(19) United States
(12) Patent Application Publication
(10) Pub. No.: US 2022/0386271 A1
(43) Pub. Date: Dec. 1, 2022

(54) SENSING WINDOW CONFIGURATION FOR SIDELINK BASED RANGING AND POSITIONING

(71) Applicant: QUALCOMM Incorporated, San Diego, CA (US)

(72) Inventors: Dan VASSILOVSKI, Del Mar, CA (US); Shuanshuan WU, San Diego, CA (US); Qing LI, Princeton Junction, NJ (US); Hong CHENG, Basking Ridge, NJ (US)

(21) Appl. No.: 17/334,252

(22) Filed: May 28, 2021

(51) Int. Cl. H04W 64/00; H04W 24/10; H04L 5/00

(52) U.S. Cl. CPC H04W 64/006; H04W 24/10; H04L 5/0051; H04W 92/18

(57) ABSTRACT

Certain aspects of the present disclosure provide techniques for sensing window configuration for sidelink based ranging and positioning. For example, during sidelink-based ranging or sensing, a user equipment (UE) may determine the relative distance or position with other UEs. This may be realized by a UE broadcasting a wideband position reference signal (PRS) on an unlicensed band and measuring the round-trip time associated with a peer UE's PRS. The measurement accounts for a PRS transmission time transmitted by each UE. The UE may apply a sensing window to determine whether a neighboring UE has reserved PRS transmission times. The present disclosure provides methods and techniques for a network entity to configure a sensing window in a UE so that the UE may determine, during the sensing window, whether neighboring UEs have reserved a PRS transmission time.

### INTRODUCTION

Aspects of the present disclosure relate to wireless communications, and more particularly, to techniques for sidelink communication.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages.

Certain aspects of the subject matter described in this disclosure can be implemented in a method for wireless communication by a network entity. The method generally includes selecting one or more parameters that define a temporal sensing window for at least a first UE (UE) to monitor for sidelink messages to identify whether one or more neighboring UEs have reserved a position reference signal (PRS) transmission time; and transmitting signaling indicating the one or more parameters to configure at least the first UE with the temporal sensing window.

Certain aspects of the subject matter described in this disclosure can be implemented in a method for wireless communication by a UE. The method generally includes receiving signaling indicating one or more parameters to configure at least the UE with a temporal sensing window, wherein the one or more parameters are selected to define the temporal sensing window to monitor for sidelink messages; and identifying whether one or more neighboring UEs have reserved a PRS transmission time according to the one or more parameters of the received signaling.

Certain aspects provide a wireless communication device. The wireless communication device includes a memory and a processor. The memory and the processor are configured to select one or more parameters that define a temporal sensing window for at least a first UE to monitor for sidelink messages to identify whether one or more neighboring UEs have reserved a PRS transmission time; and transmit signaling indicating the one or more parameters to configure at least the first UE with the temporal sensing window.

Certain aspects provide a wireless communication device. The wireless communication device includes a memory and a processor. The memory and the processor are configured to receive signaling indicating one or more parameters to configure at least the UE with a temporal sensing window, wherein the one or more parameters are selected to define the temporal sensing window to monitor for sidelink messages; and identify whether one or more neighboring UEs have reserved a PRS transmission time according to the one or more parameters of the received signaling.

Certain aspects provide a wireless communication device. The wireless communication device generally includes means for selecting one or more parameters that define a temporal sensing window for at least a first UE to monitor for sidelink messages to identify whether one or more neighboring UEs have reserved a PRS transmission time; and means for transmitting signaling indicating the one or more parameters to configure at least the first UE with the temporal sensing window.

Certain aspects provide a wireless communication device. The wireless communication device generally includes means for receiving signaling indicating one or more parameters to configure at least the UE with a temporal sensing window, wherein the one or more parameters are selected to define the temporal sensing window to monitor for sidelink messages; and means for identifying whether one or more neighboring UEs have reserved a PRS transmission time according to the one or more parameters of the received signaling.

Certain aspects provide a non-transitory computer-readable storage medium having instructions stored thereon for performing a method for wireless communication by a wireless communication device. The method generally includes selecting one or more parameters that define a temporal sensing window for at least a first UE to monitor for sidelink messages to identify whether one or more neighboring UEs have reserved a PRS transmission time; and transmitting signaling indicating the one or more parameters to configure at least the first UE with the temporal sensing window.

Certain aspects provide a non-transitory computer-readable storage medium having instructions stored thereon for performing a method for wireless communication by a wireless communication device. The method generally includes receiving signaling indicating one or more parameters to configure at least the UE with a temporal sensing window, wherein the one or more parameters are selected to define the temporal sensing window to monitor for sidelink messages; and identifying whether one or more neighboring UEs have reserved a PRS transmission time according to the one or more parameters of the received signaling.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

The following description and the appended figures set forth certain features for purposes of illustration.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5 is an exemplary transmission timeline illustrating transmissions and resource reservations by a sidelink UE, in accordance with aspects of the present disclosure.

FIG. 6 is an exemplary transmission timeline illustrating resource selection for transmission by a sidelink UE, in accordance with aspects of the present disclosure.

FIG. 7 is an exemplary transmission timeline illustrating resource selection for transmission by a sidelink UE, in accordance with aspects of the present disclosure.

FIG. 8 is a flow diagram illustrating example operations for wireless communication by a network entity, in accordance with certain aspects of the present disclosure.

FIG. 9 is a flow diagram illustrating example operations for wireless communication by a UE, in accordance with certain aspects of the present disclosure.

FIG. 10 illustrates example configuration information elements, in accordance with certain aspects of the present disclosure.

FIG. 11 illustrates example configuration information elements, in accordance with certain aspects of the present disclosure.

FIG. 12 illustrates example configuration information elements, in accordance with certain aspects of the present disclosure.

FIG. 13 illustrates a communications device that may include various components configured to perform the operations illustrated in FIG. 8, in accordance with aspects of the present disclosure.

FIG. 14 illustrates a communications device that may include various components configured to perform the operations illustrated in FIG. 9, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for sensing window configuration for sidelink based ranging and positioning. For example, during sidelink-based ranging or sensing, a user equipment (UE) may determine the relative distance or position with other UEs. This may be realized by a UE broadcasting a wideband position reference signal (PRS) on an unlicensed band and measuring the round-trip time associated with a peer UE's PRS. The measurement accounts for a PRS transmission time transmitted by each UE. Aspects of the present disclosure provides methods and techniques for a network entity to configure a sensing window in a UE so that the UE may determine, by monitoring within the sensing window, whether neighboring UEs have reserved a PRS transmission time.

For example, in an aspect, the network entity may select one or more parameters that define a temporal sensing window for at least a first UE to monitor for sidelink messages to identify whether one or more neighboring UEs have reserved a PRS transmission time. The network entity then transmits signaling indicating the one or more parameters to configure at least the first UE with the temporal sensing window.

In general, sidelink-based ranging enables sidelink UEs to determine relative distance, and/or absolute position among the sidelink UEs. This ranging technique may be valuable, for example, in situations where the global navigation satellite system (GNSS) is degraded or unavailable, such as in tunnels, urban canyons, and similar environment. Furthermore, the sidelink-based ranging technique may further enhance the range and position accuracy in concert with GNSS techniques when the GNSS is available. To realize sidelink-based ranging, a UE may broadcast a wideband Position Reference Signal (PRS) on an unlicensed band and measure the round-trip time associated with a peer UE's PRS, with individual UEs transmitting messages to a PRS transmission time.

Challenges exist that multiple UEs are engaged in a sidelink ranging session, without any inter-UE coordination. For example, PRS transmissions from peer UEs may collide with each other. In addition, the UEs may not know when to expect a peer UE's PRS transmission and may, thus, miss PRS transmissions or waste resources unnecessarily monitoring for PRS transmissions.

Aspects of the present disclosure may help address such challenges, by enabling a UE to monitor a temporal sensing window, during which the UE determines whether neighboring UEs have reserved PRS transmission times. Therefore, it is desirable to configure the temporal sensing window. According to aspects of the present disclosure, to achieve effective coordination of sensing among different UEs, the network entity (e.g., a gNB) may configure the sensing window in a UE at various levels, such as for a cell, for a group of UEs, or for individual/specific UEs. For example, a network entity may configure the temporal sensing window in a UE, such that the UE may apply the sensing window and determine if any neighboring UEs may have reserved a PRS transmission time. The network entity may configure the sensing window at a cell level via common signaling, at a UE level via dedicated signaling, or for a group of UEs via dedicated signaling.

In certain aspects, to configure the sensing window, the information elements configuring the sensing window can be incorporated in existing 3GPP signaling messages, or, in or as part of a new message specific to sidelink positioning. That is, existing signaling messages may be modified to incorporate the disclosed information elements, or new signaling messages of the disclosed information elements may be used. Such information elements used to configure a temporal sensing window for a PRS reservation request used may be part of a sidelink-based ranging session establishment. The information exchange formats of the disclosed information elements may be applicable in any sidelink UE.

The following description provides examples of sensing window configuration for sidelink based ranging and positioning, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

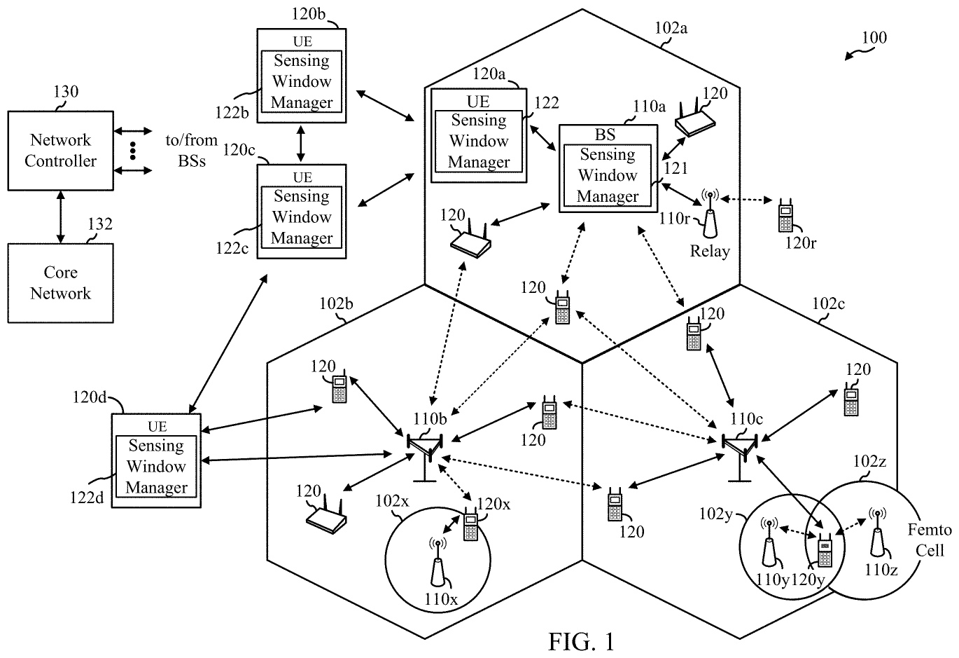

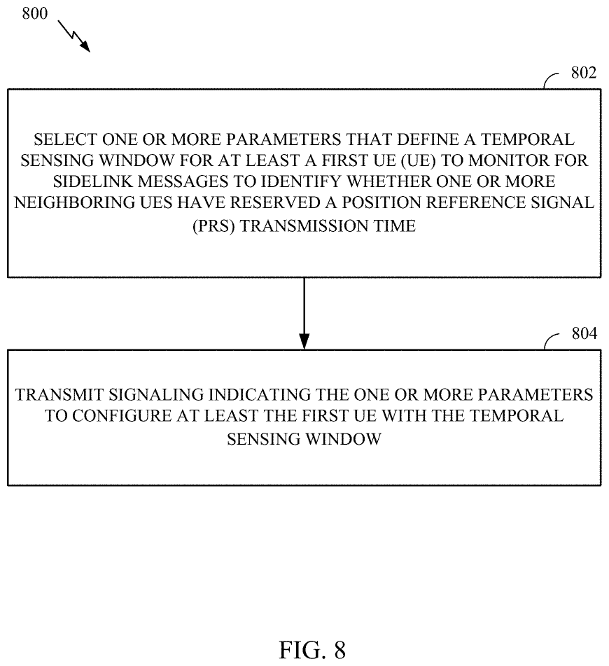

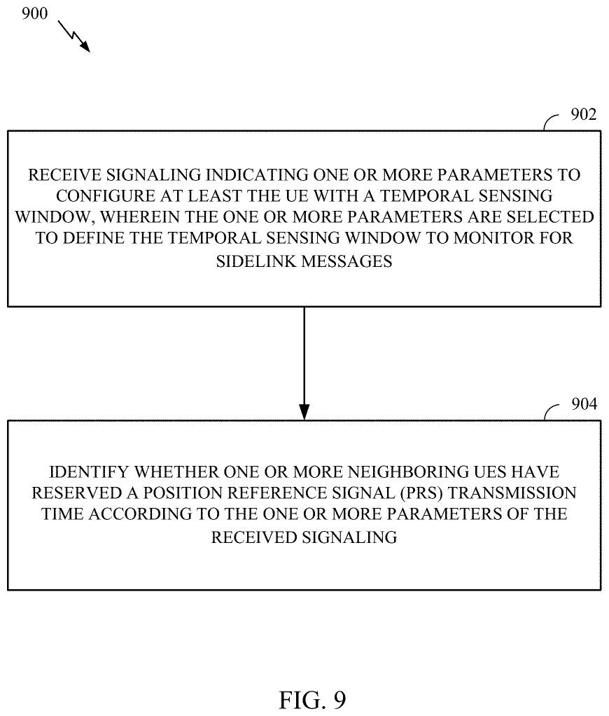

FIG. 1 illustrates an example wireless communication network 100 (e.g., an NR system or a 5G NR network), in which aspects of the present disclosure may be performed. For example, the wireless communication network 100 may include a UE 120 configured to perform operations 900 of FIG. 9 to identify whether one or more neighbor UEs have reserved a position reference signal (PRS) transmission time according to received signaling. Similarly, the wireless network 100 may include a base station 110 configured to perform operations 800 of FIG. 8 to select one or more parameters that define a temporal sensing window for a UE to monitor for sidelink messages to identify whether one or more neighboring UEs have reserved a PRS time.

As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the BSs 110 and UEs 120 may be configured for sidelink based ranging. The UE 120a includes a sensing window manager 122 that identify whether a second UE (e.g. UE 120b) has reserved a PRS transmission time according to one or more parameters selected by the sensing window manager 121 of the BS 110 for defining a temporal sensing window, in accordance with aspects of the present disclosure. The sensing window manager 122 may also transmit a first sidelink transmission to a second UE (e.g., UE 120b); and receive ranging feedback. Similarly, each of UEs 120b-120d include a similar sensing window manager 122b-122d, respectively for identifying whether one or more neighboring UEs have reserved a PRS transmission time according to the one or more parameters selected by the sensing window manager 121 of the BS 110.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

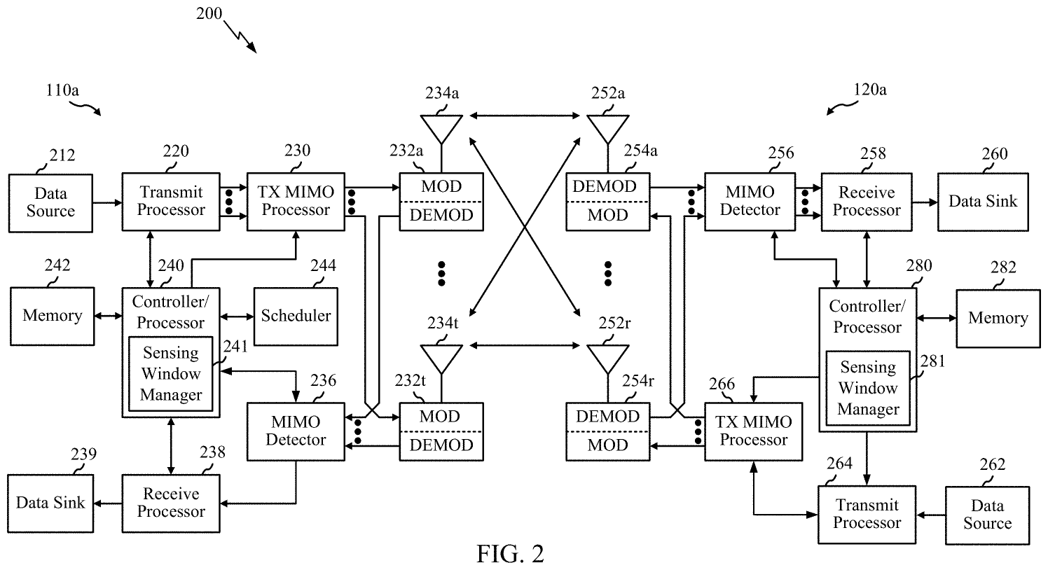

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators' 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has a sensing window manager 281 that attempts to identify whether one or more neighboring UEs have reserved a PRS transmission time according to the one or more parameters selected by the BS 110, in accordance with aspects of the present disclosure. The sensing window manager 281 may also transmit a first sidelink transmission to a second UE; and receive ranging feedback. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

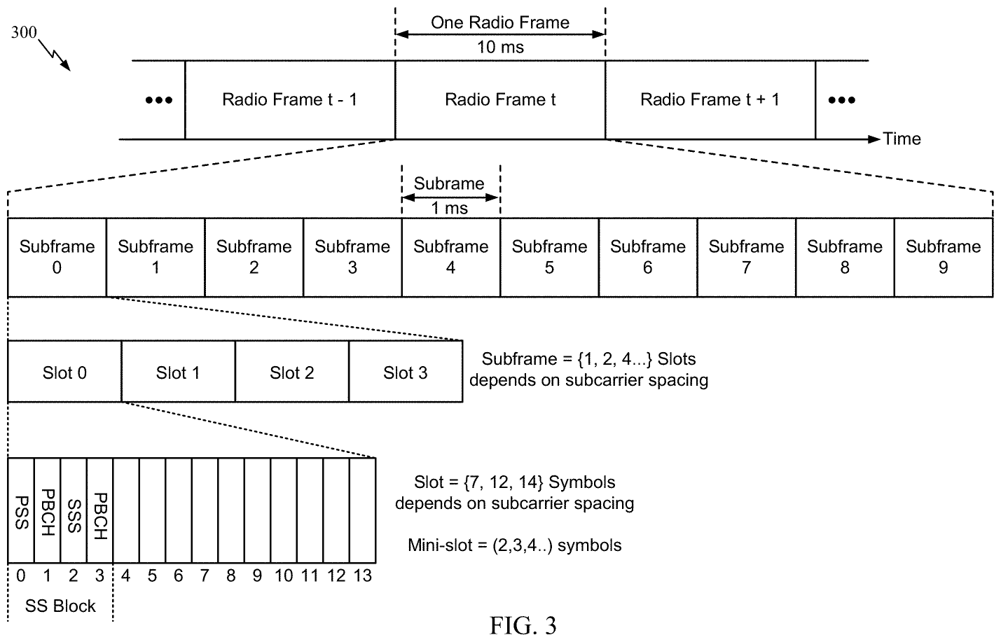

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

### Brief Introduction to NR Sidelink Communications

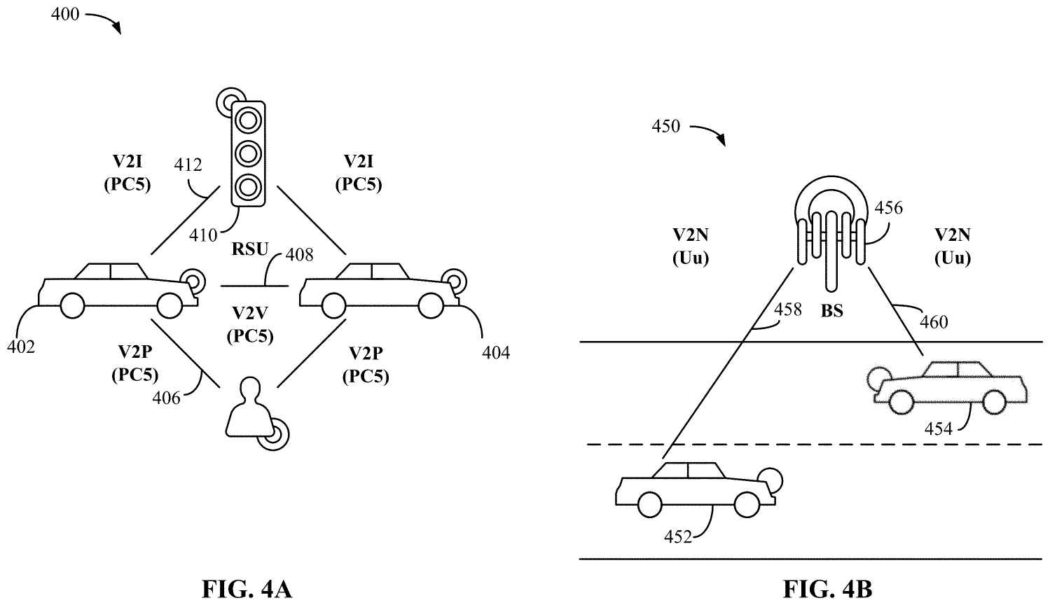

FIG. 4A and FIG. 4B show diagrammatic representations of example vehicle-to-everything (V2X) systems, in accordance with some aspects of the present disclosure. Although V2X systems are common applications of sidelink communications, sidelink communications are not limited to V2X system and may be used in any UE-to-UE applications. As shown, the vehicles shown in FIG. 4A and FIG. 4B may communicate via sidelink channels and may relay sidelink transmissions as described herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

According to aspects of the present disclosure, a UE may reserve one or more (e.g., up to two) future resources (e.g., in addition to a current resource) for a transmission (e.g., for re-transmission of a packet).

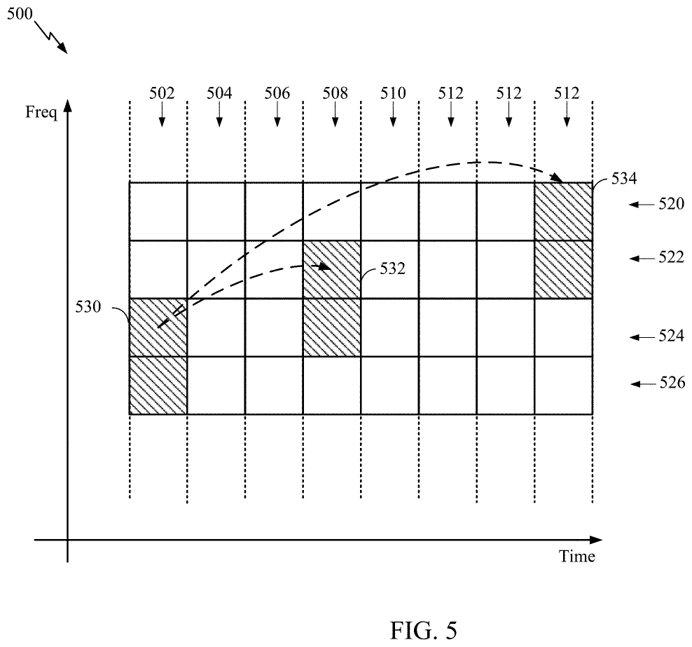

FIG. 5 is an exemplary transmission timeline 500 illustrating transmissions and resource reservations by a sidelink UE, in accordance with aspects of the present disclosure. In the exemplary transmission timeline, a UE (e.g., UE 120a, shown in FIG. 1) that is a sidelink UE transmits a sidelink transmission 530 during a slot 502 on the subchannels 524 and 526. The transmission includes data and control information that may be sent in a physical sidelink control channel (PSCCH), for example. The control information that the UE includes in transmission 530 reserves transmission resources on subchannels 522 and 524 during slot 508, as shown at 532. The control information in transmission 530 also reserves transmission resources on subchannels 520 and 522 during slot 512, as shown at 534. The transmission resources may be reserved for retransmissions of the data in the sidelink transmission 530, for example.

According to aspects of the present disclosure, channel access and resource reservation may be based on sensing of the channel by a UE with data to transmit. In an example, the UE first identifies available resources for sidelink transmissions, which may be referred to as candidate resources. The UE then selects one or more resources, from the candidate resources, for transmission of a data or control signal. To identify available resources, the UE monitors and decodes all transmissions on the channel. The UE also measures reference signal received power (RSRP) for each of the transmissions the UE attempts to decode. The UE determines reserved resources (e.g., reserved by other UEs) according to control information in the decoded transmissions which have RSRP above a threshold. The UE may then consider other resources that are not reserved as available or candidate resources, and the UE may transmit control information reserving some of the candidate resources. When a packet arrives for transmission (e.g., arrives at lower protocol layer from a higher protocol layer in a protocol stack of the UE), the UE determines a sensing window (a window in the past), determines available resources based on SCI decoding and/or RSRP measurement in the sensing window, and then identifies available resources in a resource selection window (a window in the future) by projecting the decoding and/or measurement outcomes from the sensing window to the selection window.

In aspects of the present disclosure, to identify available resources, a UE may decode SCI to determine whether a resource in a selection window has been reserved; the measured RSRP may also be projected to a corresponding future resource, if the resource is reserved. A UE may determine a resource is available if the resource is not reserved or if the resource is reserved but RSRP of the signal is less than an RSRP threshold.

According to aspects of the present disclosure, to select a resource to use for a transmission, a UE may randomly select from the available resources.

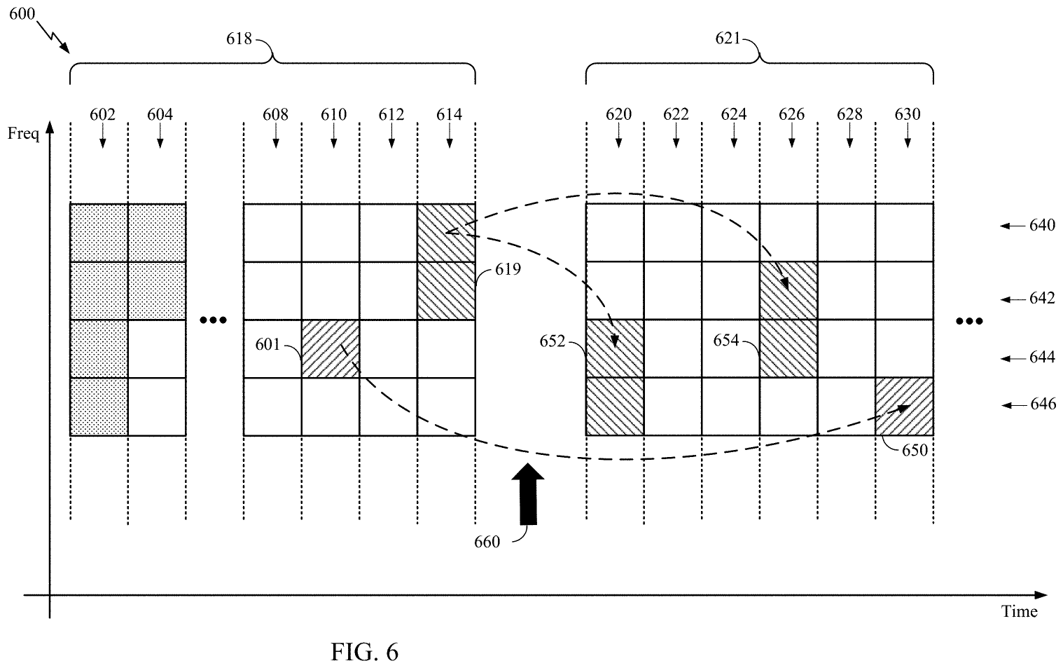

FIG. 6 is an exemplary transmission timeline 600, illustrating resource selection for transmission by a sidelink UE, in accordance with aspects of the present disclosure. The exemplary transmission timeline includes slots 602, 604, 608, 610, 612, 614, 620, 622, 624, 626, 628, and 630, as well as sub-channels 640, 642, 644, and 646. In the exemplary transmission timeline, a UE (e.g., UE 120a, shown in FIG. 1) that is a sidelink UE has a packet arrive for transmission at 660. The UE attempts to decode control information during a sensing window 618. The UE determines that control information at 601 (in slot 610 on sub-channel 644) reserves transmission resources in a selection window 621 on sub-channel 646 during slot 630, as shown at 650. The control information at 619 (in slot 614 on sub-channels 640 and 642) reserves transmission resources on subchannels 644 and 646 during slot 620, as shown at 652. The control information at 619 also reserves transmission resources on subchannels 642 and 644 during slot 626, as shown at 654.

In aspects of the present disclosure, an NR V2X or sidelink communication system may use a HARQ feedback mechanism. In an example, a first UE in an NR V2X system may transmit a data channel, and a second UE that received the transmission may send an ACK or NACK to indicate whether the second UE successfully decoded the data.

When a UE transmits data in a sidelink communication (e.g., via a physical sidelink shared channel (PSSCH)), the UE may receive HARQ feedback from other UEs receiving the sidelink communication. In an example, the HARQ feedback may be negative acknowledgment only (NACK-only) feedback, wherein a receiving UE sends a NACK when decoding of the data fails and sends nothing when decoding of the data is successful. In another example, the HARQ feedback may be ACK/NACK feedback, wherein a receiving UE sends a NACK when decoding of the data fails and sends an acknowledgment (ACK) when decoding of the data is successful.

According to aspects of the present disclosure, HARQ feedback transmission (e.g., in a physical sidelink feedback channel (PSFCH)) may happen in a configured or preconfigured PSFCH resource, which occurs in every N slots, for example where N may be 0, 1, 2, or 4. In an example, the resource used for HARQ feedback transmission acknowledging a PSSCH is determined (e.g., determined by the UE transmitting the HARQ feedback) based on: the time and frequency resources of the PSSCH; the transmitter UE identifier (ID); the receiver UE ID, if the HARQ feedback is for ACK/NACK based groupcast communication; and the type of the feedback (e.g., ACK or NACK). In an example, each HARQ feedback is transmitted in one PRB (e.g., twelve consecutive subcarriers) and two OFDM symbols in a PSFCH slot.

In aspects of the present disclosure, HARQ feedback may have 2 modes: NACK-only and ACK/NACK. In an example, the HARQ feedback may be NACK-only feedback, wherein a receiving UE sends a NACK when decoding of the data fails and sends nothing when decoding of the data is successful. In another example, the HARQ feedback may be ACK/NACK feedback, if a receiving UE sends a NACK when decoding of the data fails and sends an acknowledgment (ACK) when decoding of the data is successful.

According to aspects of the present disclosure, there may be multiple PSFCH resources configured corresponding to a PSSCH transmission. In an example, multiple resources may be used for groupcast ACK/NACK feedback, so different receiving UEs in the group may each transmit feedback in a different PSFCH resource.

In aspects of the present disclosure, in a situation where multiple transmitting UEs transmit data in a same resource (e.g., a data collision), multiple HARQ resource mapping (e.g., multiple HARQ resources for each of the PSSCHs that collided) may alleviate a potential collision between the HARQ transmissions.

Example Sensing Window Configuration for Sidelink Based Ranging and Positioning

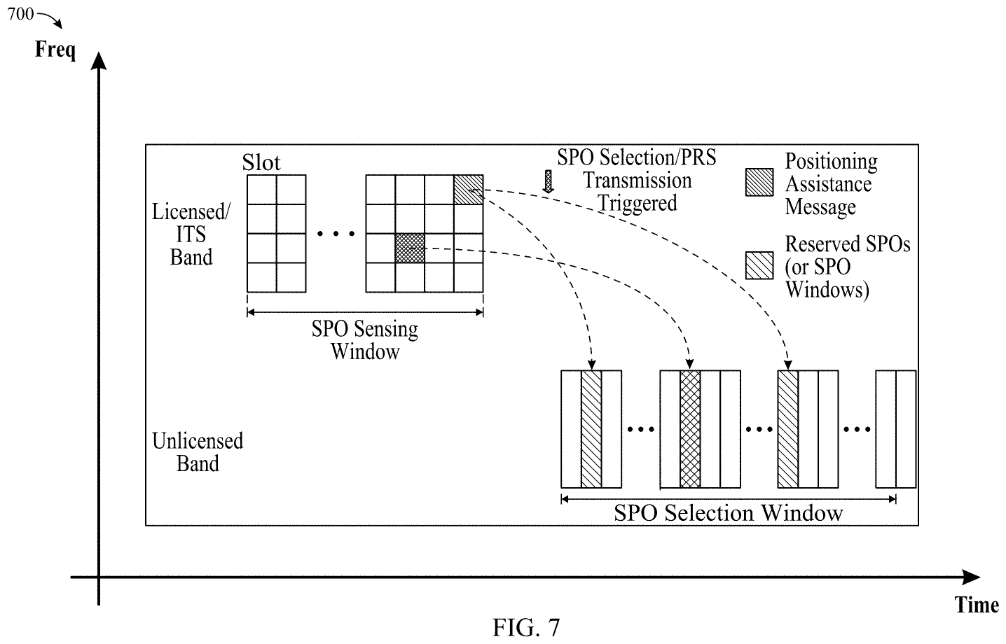

FIG. 7. is an exemplary transmission timeline 700 illustrating resource selection for transmission by a sidelink UE, in accordance with aspects of the present disclosure. As shown, the UE may use both a licensed band and an unlicensed band for ranging operations. In certain aspects, the PRS reservation message may be transmitted by a UE on a sidelink data channel (PSSCH) as medium access control (MAC) control element (CE), or radio resource control (RRC) signaling. In order to avoid overlapping reservations, such signaling may be introduced to coordinate UEs that wish to participate in a ranging session and to coordinate reservation times among the participating UEs. As a result, such signaling may incur substantial latency and implementation complexity.

To avoid such latency and complexity, a distributed approach may be utilized: each UE may apply a temporal sensing window, during which each UE determines whether other UEs have issued a PRS reservation request. As shown in FIG. 7, the sensing window in the licensed band may be mapped to a PRS selection window in the unlicensed band. That is, a UE may transmit its PRS reservation based on the reservations the UE has sensed or heard during the sensing window. As a result, each UE may transmit its PRS reservation based on a determination of available PRS transmission times.

In certain aspects, sidelink ranging sessions may be ad-hoc or based on predefined groups (e.g., vehicle platoons). The ranging sessions may involve varying numbers of UEs. In some cases, the ranging sessions may be managed by the UEs or managed by a network entity. Different sensing window durations may be tailored to specific scenarios. For example, the network (e.g., a gNB) observing or capable of monitoring various aspects of the scenarios may be able to configure corresponding sensing window durations accordingly.

In the example shown in FIG. 7, the sensing window may be for reservation of sidelink PRS occasions (SPO). When SPO reservation or PRS transmission is triggered at the UE, the UE may look back to a SPO sensing window, during which the UE may have decoded sidelink positioning assistance message from other UEs. Based on the SPO reservation indicated by the decoded assistance messages, the UE may be able to identify available resources in a SPO selection window; the UE then selects SPO from available resources in the selection window. For reservation based PRS transmission, collision of PRS from different UEs may be reduced/eliminated even though UEs may be operating in a distributed manner. As shown, the sensing window is in the licensed/ITS spectrum, while the selection window is in the unlicensed spectrum.

As discussed, when multiple UEs are engaged in a ranging session, without any inter-UE coordination, PRS transmissions from peer UEs may collide, and/or UEs may not know when to expect a peer UE's PRS transmission. Accordingly, it is desirable to develop techniques and apparatus for a UE to apply a temporal sensing window, during which the UE determines if neighboring UEs have reserved PRS transmission times. For effective coordination of sensing among different UEs, the present disclosure provides techniques for enabling the network (e.g., a gNB) to configure the sensing window for a cell, for a group of UEs, or for individual UEs.

Aspects of the present disclosure provide apparatus, methods, processing systems, and computer readable mediums for sensing window configuration for sidelink based ranging and positioning. For example, during sidelink-based ranging or sensing, a user equipment (UE) may determine the relative distance or position with other UEs. This may be realized by a UE broadcasting a wideband position reference signal (PRS) on an unlicensed band and measuring the round-trip time associated with a peer UE's PRS. The measurement accounts for a PRS transmission time transmitted by each UE. The UE may apply a sensing window to determine whether a neighboring UE has reserved PRS transmission times. The present disclosure provides methods and techniques for a network entity to configure a sensing window in a UE so that the UE may determine, during the sensing window, whether neighboring UEs have reserved a PRS transmission time.

In aspects of the present disclosure, a UE may receive signaling indicating one or more parameters to configure at least the UE with a temporal sensing window. The one or more parameters are selected to define the temporal sensing window to monitor for sidelink messages. The UE may then identify whether one or more neighboring UEs have reserved a PRS transmission time according to the one or more parameters of the received signaling.

According to aspects of the present disclosure, various information elements may be modified or added to enable the network to configure the sensing window as discussed. In some cases, the network may transmit information element definitions as a common configuration, to cause cell-wide configurations. In some cases, the network may transmit information element definitions as a UE-specific configuration, to cause configurations dedicated to one or more UEs.

For example, the PRS reservation window may be specified as a configurable range or as an enumerated list. In one example, the list may include SL-UE-PRSConfig field descriptions, such as an sl-PRSReservationSensingWindow, or other similar field descriptions. Within such information element, the parameter that determines the end of the PRS reservation selection window may be specified in values in milliseconds. For example, Value 0 corresponds to 0 ms; Value 1 corresponds to 1 ms; Value 10 corresponds to 10 ms and so on.

In another example, the PRS reservation window may be specified as a configurable range, such as:

```
  SL-UE-PRSConfig-r16 : := SEQUENCE {
    sl-PRSReservationSensingWindow INTERGER { 0. 1000
}
  ..
  }
```

In yet another example, the PRS reservation window may be specified as an enumerated list, such as:

```
  SL-UE-PRSConfig-r16 : := SEQUENCE {
    sl-PRSReservationSensingWindow ENUMERATED { ms0,
ms20, ms40, ms60, ms80, ms100, ms150, ms200}
  ..
  }
```

FIG. 8 is a flow diagram illustrating example operations 800 for wireless communication, in accordance with certain aspects of the present disclosure. The operations 800 may be performed, for example, by a network entity (e.g., the BS 110 in the wireless communication network 100 of FIG. 1). The operations 800 may be implemented as software components that are executed and run on one or more processors (e.g., controller/processor 240 of FIG. 2). Further, the transmission and reception of signals by the UE in operations 800 may be enabled, for example, by one or more antennas (e.g., antennas 234 of FIG. 2). In certain aspects, the transmission and/or reception of signals by the UE may be implemented via a bus interface of one or more processors (e.g., controller/processor 280) obtaining and/or outputting signals.

The operations 800 may begin, at 802, by selecting one or more parameters that define a temporal sensing window for at least a first UE to monitor for sidelink messages to identify whether one or more neighboring UEs have reserved a PRS transmission time.

Operations 800 may continue, at 804, by transmitting signaling indicating the one or more parameters to configure at least the first UE with the temporal sensing window.

FIG. 9 is a flow diagram illustrating example operations 900 for wireless communication, in accordance with certain aspects of the present disclosure. The operations 900 may be performed, for example, by a UE (e.g., the UE 120a in the wireless communication network 100). The operations 900 may be complimentary to the operations 800 performed by the network entity.

The operations 900 may be implemented as software components that are executed and run on one or more processors (e.g., controller/processor 280 of FIG. 2). Further, the transmission and reception of signals by the UE in operations 900 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 900 may begin, at 902, by receiving signaling indicating one or more parameters to configure at least the UE with a temporal sensing window, wherein the one or more parameters are selected to define the temporal sensing window to monitor for sidelink messages.

Operations 900 may continue, at 904, by identifying whether one or more neighboring UEs have reserved a PRS transmission time according to the one or more parameters of the received signaling.

In certain aspects, the one or more parameters of the temporal sensing window is a cell-wide configuration common to at least a second UE receiving the signaling from the network entity. For example, the one or more parameters may include at least a value in a system information block (SIB). In certain aspects, the one or more parameters of the temporal sensing window is applicable to configure a group of UEs including the first UE. For example, the one or more parameters may include at least a value in a radio resource control (RRC) reconfiguration message.

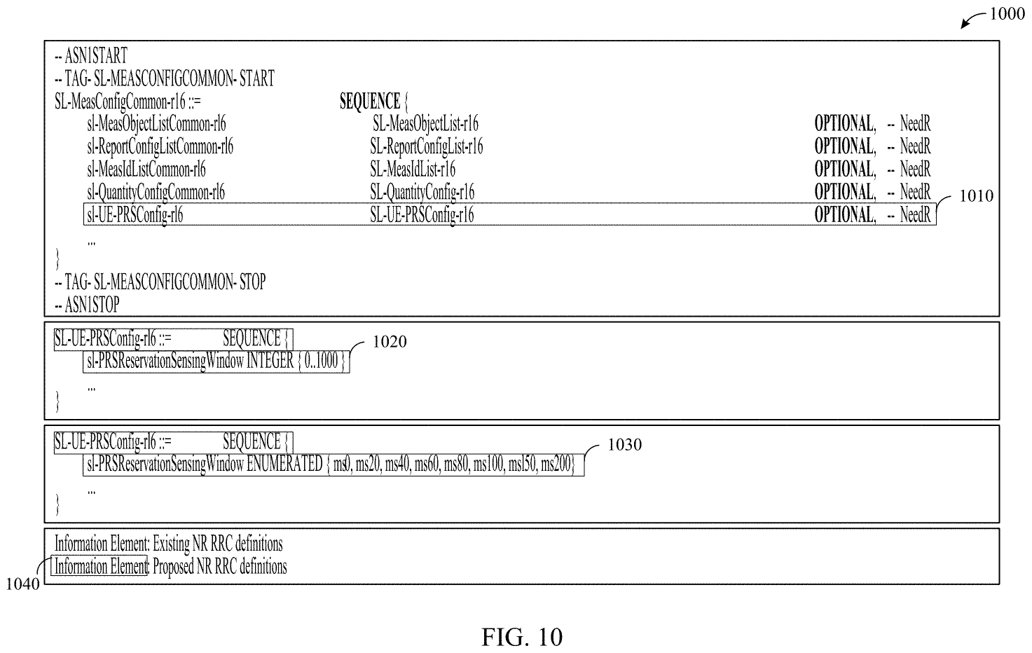

In some cases, the singling of the one or more parameters to configure a temporal sensing window may be indicated in an information element (IE), as shown in FIGS. 10-12.

FIG. 10 illustrates example configuration information elements 1000, in accordance with certain aspects of the present disclosure. As shown, the information elements in FIG. 10 may configure a common cell-wide sensing window, such as in a SIB (e.g., SIB12 for NR sidelink common configuration). For example, the proposed information elements may be a sidelink PRS reservation sensing window (e.g., sl-PRSReservationSensing Window), which can be a part of a new information element, or can be incorporated into SIB12 through one or more information elements, such as a group common sidelink measurement configuration (e.g., sl-MeasConfigCommon), and/or a list of sidelink frequency information (e.g., sl-FreqInfoList).

As shown in FIG. 10, MeasConfigCommon further includes sl-UE-PRSConfig-r16 1010 for the cell-wide sensing window configuration. Further, SL-UE-PRSConfig-r16 may include sl-PRSReservationSensingWindow, which may be indicated in a range of integers 1020 or as enumerated values 1030. In addition, FIG. 10 also illustrates adding new information elements 1040 for the RRC definitions related to the sensing window in addition to existing RRC definitions.

In some cases, the one or more parameters of the temporal sensing window may include at least a value in a radio resource control (RRC) reconfiguration message. In some cases, the value may be indicated in a dedicated sidelink configuration information element (e.g., SL-ConfigDedicatedNR). In some cases, the one or more parameters of the temporal sensing window are applicable to configure a group of UEs including the first UE. For example, the group of UEs may be in sidelink communications with each other.

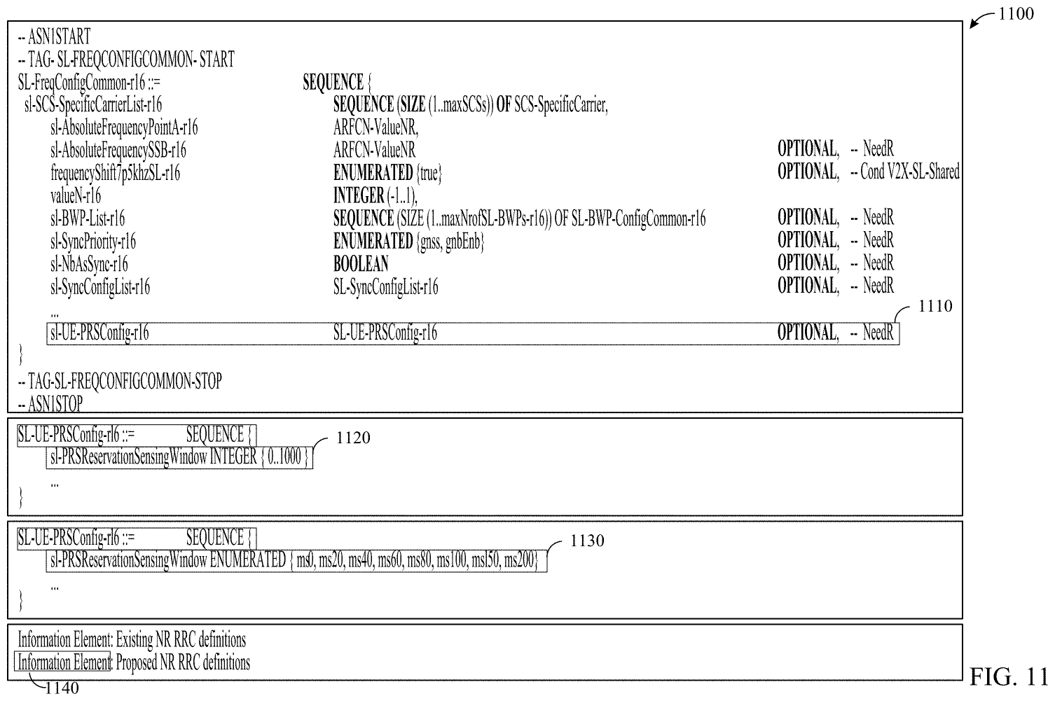

FIG. 11 illustrates example configuration information elements 1100, in accordance with certain aspects of the present disclosure. As shown, the proposed information elements, such as sl-PRSReservationSensingWindow, can be incorporated into SIB12 through sl-FreqInfoList (i.e., SL-FreqConfigCommon-r16). The SL-PRSConfig-r16 1110 may include sl-PRSReservationSensingWindow, which may also be indicated in a range of integers 1120 or as enumerated values 1130. Furthermore, FIG. 11 also illustrates adding new information elements 1140 for the RRC definitions related to the sensing window in addition to existing RRC definitions.

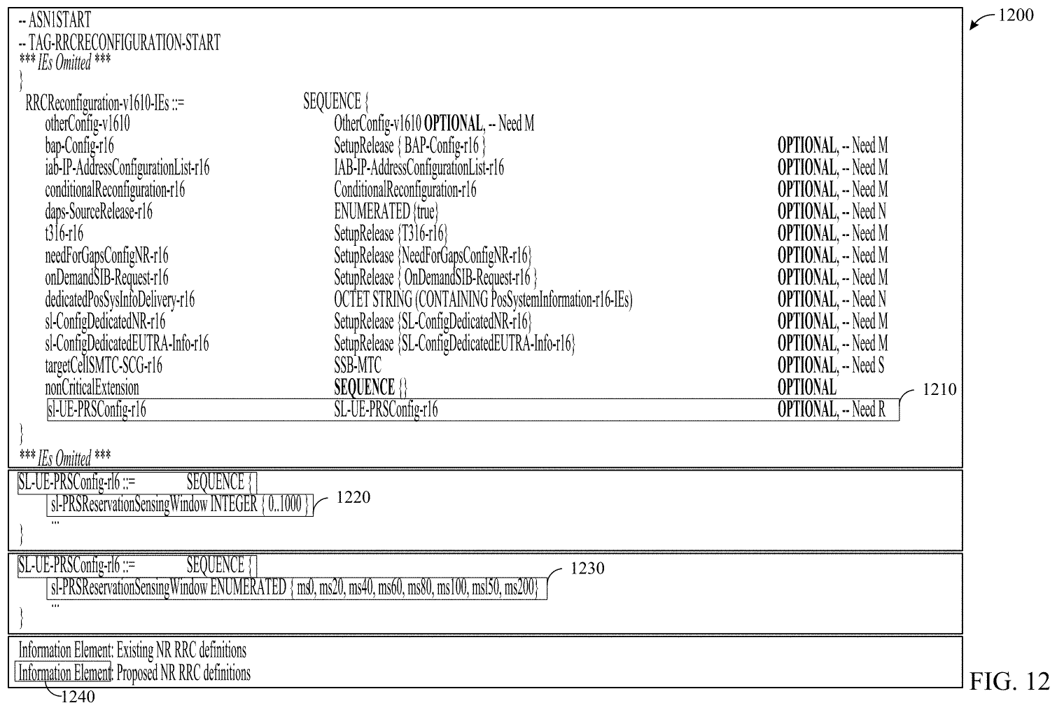

FIG. 12 illustrates example configuration information elements 1200, in accordance with certain aspects of the present disclosure. The information elements 1200 provides UE-specific sensing window via dedicated configuration, such as through RRCReconfiguration messages. The proposed information element (i.e., sl-PRSReservationSensingWindow) can be incorporated into the RRCReconfiguration-v1610-IEs through one or more information elements, such as sl-UE-PRSConfig-r16 1210. The sl-UE-PRSConfig-r16 1210 may include sl-PRSReservationSensingWindow, which may also be indicated in a range of integers 1220 or as enumerated values 1230. Similar to the examples shown in FIGS. 10 and 11, new information elements 1240 for the RRC definitions related to the sensing window may be added in addition to existing RRC definitions.

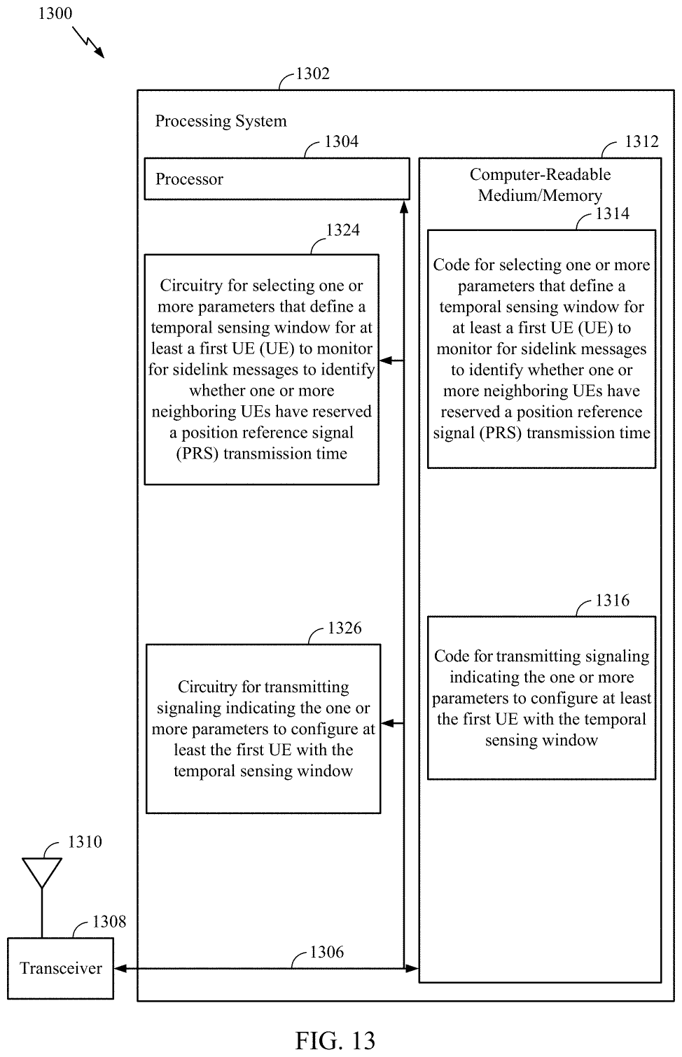

FIG. 13 illustrates a communications device 1300 that may include various components (e.g., corresponding to means-plus-function components) configured to perform operations for the techniques disclosed herein, such as the operations illustrated in FIG. 8. The communications device 1300 may be an example of means for performing various aspects of configuring sensing or ranging windows, for a sidelink communication, as described herein. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The communications device 1300, or its sub-components, may be implemented in code (e.g., as communications management software or firmware) executed by a processor, or any combination thereof. If implemented in code executed by a processor, the functions of the communications device 1300, or its sub-components may be executed by a general-purpose processor, a digital signal processor (DSP), an application-specific integrated circuit (ASIC), a field programmable gate array (FPGA) or other programmable logic device. The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 8, or other operations for performing the various techniques discussed herein for sensing window configuration for sidelink based ranging and positioning. In certain aspects, computer-readable medium/memory 1312 stores code 1314 for selecting one or more parameters that define a temporal sensing window for at least a first user equipment (UE) to monitor for sidelink messages to identify whether one or more neighboring UEs have reserved a position reference signal (PRS) transmission time; and code 1316 for transmitting signaling indicating the one or more parameters to configure at least the first UE with the temporal sensing window.

In another implementation, the communications device 1300, or its sub-components, may be implemented in hardware (e.g., in sensing window management circuitry). The circuitry may comprise a processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure. In certain aspects, the processor 1304 has circuitry configured to implement the code stored in the computer-readable medium/memory 1312. The processing system 1302 includes circuitry (e.g., an example of means for) 1324 for selecting one or more parameters that define a temporal sensing window for at least a first user equipment (UE) to monitor for sidelink messages to identify whether one or more neighboring UEs have reserved a position reference signal (PRS) transmission time; and circuitry (e.g., an example of means for) 1326 for transmitting signaling indicating the one or more parameters to configure at least the first UE with the temporal sensing window.

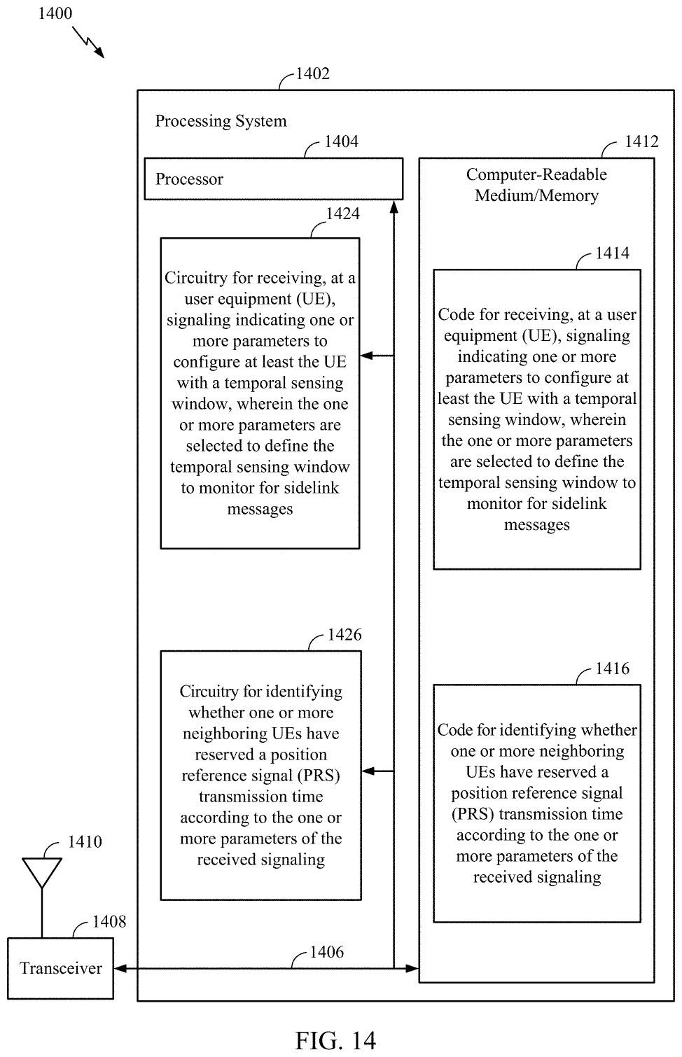

FIG. 14 illustrates a communications device 1400 that may include various components (e.g., corresponding to means-plus-function components) configured to perform operations for the techniques disclosed herein, such as the operations illustrated in FIG. 9. The communications device 1400 may be an example of means for performing various aspects of configuring sensing or ranging windows, for a sidelink communication, as described herein. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The communications device 1400, or its sub-components, may be implemented in code (e.g., as communications management software or firmware) executed by a processor, or any combination thereof. If implemented in code executed by a processor, the functions of the communications device 1400, or its sub-components may be executed by a general-purpose processor, a digital signal processor (DSP), an application-specific integrated circuit (ASIC), a field programmable gate array (FPGA) or other programmable logic device. The processing system 1402 includes a processor 1404 coupled to a computer-readable medium/memory 1414 via a bus 1406. In certain aspects, the computer-readable medium/memory 1414 is configured to store instructions (e.g., computer-executable code) that when executed by the processor 1404, cause the processor 1404 to perform the operations illustrated in FIG. 9, or other operations for performing the various techniques discussed herein for configuring sensing or ranging windows, for a sidelink communication, as described herein. In certain aspects, computer-readable medium/memory 1414 stores code 1414 for receiving signaling indicating one or more parameters to configure at least the UE with a temporal sensing window, wherein the one or more parameters are selected to define the temporal sensing window to monitor for sidelink messages, and code 1416 for identifying whether one or more neighboring UEs have reserved a position reference signal (PRS) transmission time according to the one or more parameters of the received signaling.

In another implementation, the communications device 1400, or its sub-components, may be implemented in hardware (e.g., in sensing window management circuitry). The circuitry may comprise a processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure. In certain aspects, the processing system 1402 has circuitry configured to implement the code stored in the computer-readable medium/memory 1414. The processor 1404 includes circuitry (e.g., an example of means for) 1424 receiving signaling indicating one or more parameters to configure at least the UE with a temporal sensing window, wherein the one or more parameters are selected to define the temporal sensing window to monitor for sidelink messages; and circuitry (e.g., an example of means for) 1426 for identifying whether one or more neighboring UEs have reserved a position reference signal (PRS) transmission time according to the one or more parameters of the received signaling.

### EXAMPLE ASPECTS

Aspect 1: A method for wireless communications by a network entity, comprising: selecting one or more parameters that define a temporal sensing window for at least a first user equipment (UE) to monitor for sidelink messages to identify whether one or more neighboring UEs have reserved a position reference signal (PRS) transmission time; and transmitting signaling indicating the one or more parameters to configure at least the first UE with the temporal sensing window.

Aspect 2: The method of Aspect 1, wherein the one or more parameters of the temporal sensing window is a cell-wide configuration common to at least a second UE receiving the signaling from the network entity.

Aspect 3: The method of Aspect 1 or 2, wherein the one or more parameters comprise at least a value in a system information block (SIB).

Aspect 4: The method of any one of Aspects 1 to 3, wherein the signaling of the one or more parameters is indicated in an information element.

Aspect 5: The method of Aspect 4, wherein the information element comprises at least one of the following fields: a group common sidelink measurement configuration, or a list of sidelink frequency information.

Aspect 6: The method of any one of Aspects 1 to 5, wherein the one or more parameters of the temporal sensing window is applicable to configure a group of UEs including the first UE.

Aspect 7: The method of any one of Aspects 1 to 6, wherein the one or more parameters comprise at least a value in a radio resource control (RRC) reconfiguration message.

Aspect 8: The method of Aspect 7, wherein the value is indicated in an information element provided in a dedicated sidelink configuration.

Aspect 9: A method for wireless communications by a user equipment (UE), comprising: receiving signaling indicating one or more parameters to configure at least the UE with a temporal sensing window, wherein the one or more parameters are selected to define the temporal sensing window to monitor for sidelink messages; and identifying whether one or more neighboring UEs have reserved a position reference signal (PRS) transmission time according to the one or more parameters of the received signaling.

Aspect 10: The method of Aspect 9, wherein the one or more parameters of the temporal sensing window is a cell-wide configuration common to at least a second UE receiving the signaling from the network entity.

Aspect 11: The method of Aspect 9 or 10, wherein the one or more parameters comprise at least a value in a system information block (SIB).

Aspect 12: The method of any one of Aspects 9 to 11, wherein the signaling of the one or more parameters is indicated in an information element.

Aspect 13: The method of Aspect 12, wherein the information element comprises at least one of the following fields: a group common sidelink measurement configuration, or a list of sidelink frequency information.

Aspect 14: The method of any one of Aspects 9 to 13, wherein the one or more parameters of the temporal sensing window is applicable to configure a group of UEs including the first UE.

Aspect 15: The method of Aspect 14, wherein the one or more parameters comprise at least a value in a radio resource control (RRC) reconfiguration message.

Aspect 16: The method of Aspect 15, wherein the value is indicated in an information element provided in a dedicated sidelink configuration.

Aspect 17: An apparatus for wireless communications by a network entity, comprising: a memory; and a processor coupled to the memory, the memory and the processor configured to: select one or more parameters that define a temporal sensing window for at least a first user equipment (UE) to monitor for sidelink messages to identify whether one or more neighboring UEs have reserved a position reference signal (PRS) transmission time; and transmit signaling indicating the one or more parameters to configure at least the first UE with the temporal sensing window.

Aspect 18: The apparatus of Aspect 17, wherein the one or more parameters of the temporal sensing window is a cell-wide configuration common to at least a second UE receiving the signaling from the network entity.

Aspect 19: The apparatus of Aspect 17 or 18, wherein the one or more parameters comprise at least a value in a system information block (SIB).

Aspect 20: The apparatus of any one of Aspects 17 to 19, wherein the signaling of the one or more parameters is indicated in an information element.

Aspect 21: The apparatus of Aspect 20, wherein the information element comprises at least one of the following fields: a group common sidelink measurement configuration, or a list of sidelink frequency information.

Aspect 22: The apparatus of any one of Aspects 17 to 21, wherein the one or more parameters of the temporal sensing window is applicable to configure a group of UEs including the first UE.

Aspect 23: The apparatus of Aspect 22, wherein the one or more parameters comprise at least a value in a radio resource control (RRC) reconfiguration message.

Aspect 24: The apparatus of Aspect 23, wherein the value is indicated in an information element provided in a dedicated sidelink configuration.

Aspect 25: An apparatus for wireless communications by a user equipment (UE), comprising: a memory; and a processor coupled to the memory, the memory and the processor configured to: receive signaling indicating one or more parameters to configure at least the UE with a temporal sensing window, wherein the one or more parameters are selected to define the temporal sensing window to monitor for sidelink messages; and identify whether one or more neighboring UEs have reserved a position reference signal (PRS) transmission time according to the one or more parameters of the received signaling.

Aspect 26: The apparatus of Aspect 25, wherein the one or more parameters of the temporal sensing window is a cell-wide configuration common to at least a second UE receiving the signaling from the network entity.

Aspect 27: The apparatus of Aspect 25 or 26, wherein the one or more parameters comprise at least a value in a system information block (SIB).

Aspect 28: The apparatus of any one of Aspects 25 to 27, wherein the signaling of the one or more parameters is indicated in an information element.

Aspect 29: The apparatus of Aspect 28, wherein the information element comprises at least one of the following fields: a group common sidelink measurement configuration, or a list of sidelink frequency information.

Aspect 30: The apparatus of any one of Aspects 25 to 29, wherein the one or more parameters of the temporal sensing window is applicable to configure a group of UEs including the first UE.

Aspect 31: An apparatus for wireless communications, comprising means for performing one or more of the methods of Aspects 1-8.

Aspect 32: An apparatus for wireless communications, comprising means for performing one or more of the methods of Aspects 9-16.

Aspect 33: A computer-readable medium, the medium including instructions that, when executed by a processing system, cause the processing system to perform the method of one or more of Aspects 1-8.

Aspect 34: A computer-readable medium, the medium including instructions that, when executed by a processing system, cause the processing system to perform the method of one or more of Aspects 9-16.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 8 and/or FIG. 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation and details of the methods and apparatus described above without departing from the scope of the claims.

What is claimed is:

1. A method for wireless communications by a network entity, comprising:
selecting one or more parameters that define a temporal sensing window for at least a first user equipment (UE) to monitor for sidelink messages to identify whether one or more neighboring UEs have reserved a position reference signal (PRS) transmission time; and
transmitting signaling indicating the one or more parameters to configure at least the first UE with the temporal sensing window.

2. The method of claim 1, wherein the one or more parameters of the temporal sensing window is a cell-wide configuration common to at least a second UE receiving the signaling from the network entity.

3. The method of claim 2, wherein the one or more parameters comprise at least a value in a system information block (SIB).

4. The method of claim 3, wherein the signaling of the one or more parameters is indicated in an information element.

5. The method of claim 4, wherein the information element comprises at least one of the following fields: a group common sidelink measurement configuration, or a list of sidelink frequency information.

6. The method of claim 1, wherein the one or more parameters of the temporal sensing window is applicable to configure a group of UEs including the first UE.

7. The method of claim 6, wherein the one or more parameters comprise at least a value in a radio resource control (RRC) reconfiguration message.

8. The method of claim 7, wherein the value is indicated in an information element provided in a dedicated sidelink configuration.

9. A method for wireless communications by a user equipment (UE), comprising:
receiving signaling indicating one or more parameters to configure at least the UE with a temporal sensing window, wherein the one or more parameters are selected to define the temporal sensing window to monitor for sidelink messages; and
identifying whether one or more neighboring UEs have reserved a position reference signal (PRS) transmission time according to the one or more parameters of the received signaling.

10. The method of claim 9, wherein the one or more parameters of the temporal sensing window is a cell-wide configuration common to at least a second UE receiving the signaling from the network entity.

11. The method of claim 10, wherein the one or more parameters comprise at least a value in a system information block (SIB).

12. The method of claim 11, wherein the signaling of the one or more parameters is indicated in an information element.

13. The method of claim 12, wherein the information element comprises at least one of the following fields: a group common sidelink measurement configuration, or a list of sidelink frequency information.

14. The method of claim 9, wherein the one or more parameters of the temporal sensing window is applicable to configure a group of UEs including the first UE.

15. The method of claim 14, wherein the one or more parameters comprise at least a value in a radio resource control (RRC) reconfiguration message.

16. The method of claim 15, wherein the value is indicated in an information element provided in a dedicated sidelink configuration.

17. An apparatus for wireless communications by a network entity, comprising:
a memory; and
a processor coupled to the memory, the memory and the processor configured to:
select one or more parameters that define a temporal sensing window for at least a first user equipment (UE) to monitor for sidelink messages to identify whether one or more neighboring UEs have reserved a position reference signal (PRS) transmission time; and
transmit signaling indicating the one or more parameters to configure at least the first UE with the temporal sensing window.

18. The apparatus of claim 17, wherein the one or more parameters of the temporal sensing window is a cell-wide configuration common to at least a second UE receiving the signaling from the network entity.

19. The apparatus of claim 18, wherein the one or more parameters comprise at least a value in a system information block (SIB).

20. The apparatus of claim 19, wherein the signaling of the one or more parameters is indicated in an information element.

21. The apparatus of claim 20, wherein the information element comprises at least one of the following fields: a group common sidelink measurement configuration, or a list of sidelink frequency information.

22. The apparatus of claim 17, wherein the one or more parameters of the temporal sensing window is applicable to configure a group of UEs including the first UE.

23. The apparatus of claim 22, wherein the one or more parameters comprise at least a value in a radio resource control (RRC) reconfiguration message.

24. The apparatus of claim 23, wherein the value is indicated in an information element provided in a dedicated sidelink configuration.

25. An apparatus for wireless communications by a user equipment (UE), comprising:
a memory; and
a processor coupled to the memory, the memory and the processor configured to:
receive signaling indicating one or more parameters to configure at least the UE with a temporal sensing window, wherein the one or more parameters are selected to define the temporal sensing window to monitor for sidelink messages; and
identify whether one or more neighboring UEs have reserved a position reference signal (PRS) transmission time according to the one or more parameters of the received signaling.

26. The apparatus of claim 25, wherein the one or more parameters of the temporal sensing window is a cell-wide configuration common to at least a second UE receiving the signaling from the network entity.

27. The apparatus of claim 26, wherein the one or more parameters comprise at least a value in a system information block (SIB).

28. The apparatus of claim 27, wherein the signaling of the one or more parameters is indicated in an information element.

29. The apparatus of claim 28, wherein the information element comprises at least one of the following fields: a group common sidelink measurement configuration, or a list of sidelink frequency information.

30. The apparatus of claim 25, wherein the one or more parameters of the temporal sensing window is applicable to configure a group of UEs including the first UE.
